(19) United States
(12) Patent Application Publication
(10) Pub. No.: US 2018/0267728 A1
(43) Pub. Date: Sep. 20, 2018

(54) PROVISIONING VOLUMES

(71) Applicant: HEWLETT PACKARD ENTERPRISE DEVELOPMENT LP, Houston, TX (US)

(72) Inventors: Garth Booth, Fremont, CA (US); Jasmeer Kuppavilakom Abdulvahid, Fremont, CA (US); Gloria Fang Gu, Roseville, CA (US); Anthony Michael Lee, Roseville, CA (US); Kurt Frederick Martin, Roseville, CA (US); Joseph Vokt, Fremont, CA (US)

(21) Appl. No.: 15/764,202

(22) PCT Filed: Feb. 11, 2016
(86) PCT No.: PCT/US2016/017461

§ 371 Date: Mar. 28, 2018

(51) Int. Cl. G06F 3/06

(52) U.S. Cl. CPC G06F 3/0631; G06F 3/0604; G06F 3/067; G06F 3/0647; G06F 3/0653; G06F 3/0644

(57) ABSTRACT

An example of the present techniques receives a volume provisioning request in a storage management system. The volume provisioning request corresponds to a service level agreement (SLA) for a volume and includes a number of performance parameters for the volume. A database of historical performance data for each of a number of arrays in a storage pool is accessed. A fitness score for each array is calculated based on the performance parameters. A federation structure including a number of arrays in the storage pool to provision the volume is generated based on the fitness scores of the arrays. The volume is then provisioned based, at least in part, on the federation structure.

### BACKGROUND

Volume provisioning requests can include many requirements and capabilities that specify characteristics of storage to be used to place a volume.

### BRIEF DESCRIPTION OF THE DRAWINGS

Certain examples are described in the following detailed description and in reference to the drawings, in which:

FIG. 1 is a schematic diagram of an example system that can provision volumes based on historical performance data;

FIG. 2 is a schematic diagram of an example system that can provision, monitor and migrate volumes based on performance data;

FIG. 3 is a block diagram showing an example system that can provision, monitor and migrate volumes;

FIG. 4 is a process flow diagram showing an example method of provisioning volumes based on historical performance data;

FIG. 5 is a process flow diagram showing an example method of monitoring and migrating volumes based on performance data; and

FIG. 6 is a block diagram showing an example non-transitory, tangible computer-readable medium that stores code for provisioning and monitoring of volumes.

### DETAILED DESCRIPTION

As mentioned above, volume provisioning requests can include many requirements and capabilities that specify characteristics of storage to be used to place a volume. Requirements may include remaining storage capacity on the device, performance of the device, and tiers of storage available on the device. For example, performance can be measured in terms of total Input/Output Operations per second (IOPS), total bandwidth, or latency (or any combination of those capabilities). Tiers of storage can include, for example, solid-state drives (SSD), Serial Attached SCSI (SAS), or Nearline (NL) storage. Capabilities may include common storage provisioning techniques such as thin or thick provisioning as well as many other vendor unique capabilities.

Provisioning of array based block volumes for virtual or physical servers that must meet a specific service level agreement (SLA) is used to deliver mission critical workloads. Some information technology (IT) solutions normally dedicate specific hardware and overprovision resources to ensure the SLA is achieved. In other examples, resources are provisioned and managed in a much more dynamic and cost effective manner. For example, storage is pooled together to enable flexible, on demand based provisioning. Thus, there are a number of volume scheduling mechanisms that periodically collect various statistics from a pooled set of storage arrays to make provisioning decisions. For example, volumes can be provisioned based on matching requirements and capabilities, such as Input/Output Operations per Second (IOPS), total bandwidth, latency, or any combination thereof.

The present techniques use historical performance data and federations of arrays to determine a best initial volume placement and maintain provisioned performance across pooled storage. For example, historical performance services can provide an efficient way to retrieve key performance metrics such as Input/Output Operations per Second (IOPS), throughput, and latency times. The retrieved historical performance data can be used to precisely determine a best initial placement for volume requests. Performance metrics may then also be periodically monitored and used to trigger automated, efficient, array-to-array, and online volume migrations to maintain a balanced storage pool.

Accordingly, some examples described herein provide techniques for provisioning volumes. For example, a volume provisioning request may be received in a storage management system. A database of historical performance data for each of a number of arrays in a storage pool can be accessed to calculate a fitness score for each array based on performance parameters in the provisioning request. A federation structure including a number of arrays in the storage pool can be generated and used to provision the volume based on the fitness scores of the arrays. Some examples also provide for monitoring and migrating volumes. For example, performance of the arrays in the federation can be monitored for potential SLA conflicts. One or more volumes can be migrated to another array in the pool in response to detecting potential SLA conflicts.

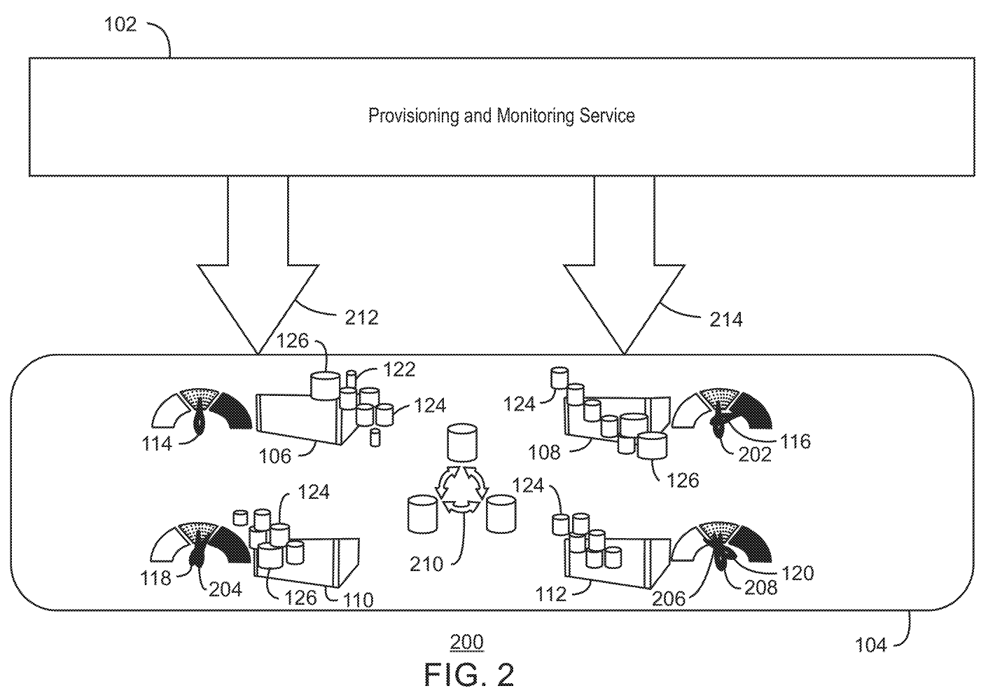

Thus, the techniques herein can be used to make more precise initial volume provisioning decisions. Moreover, the techniques may help reduce any application downtime while maintaining performance SLAs. The ability to automatically initiate online volume migrations using bi-directional peer motion ensures applications are not impacted while storage pool resources are being balanced. Peer motion, as used herein, refers to an advanced storage array technique to migrate volumes from one storage array to another without any impact to the application(s) that are using the volume and is discussed in greater detail with respect to FIG. 2 below. Further, the ability to complete the automated volume migrations without using Host CPU cycles significantly improves the overall efficiency of this solution. Together, the initial volume placement and continuous monitoring of storage pool performance to automatically redistribute volumes ensures improved application performance.

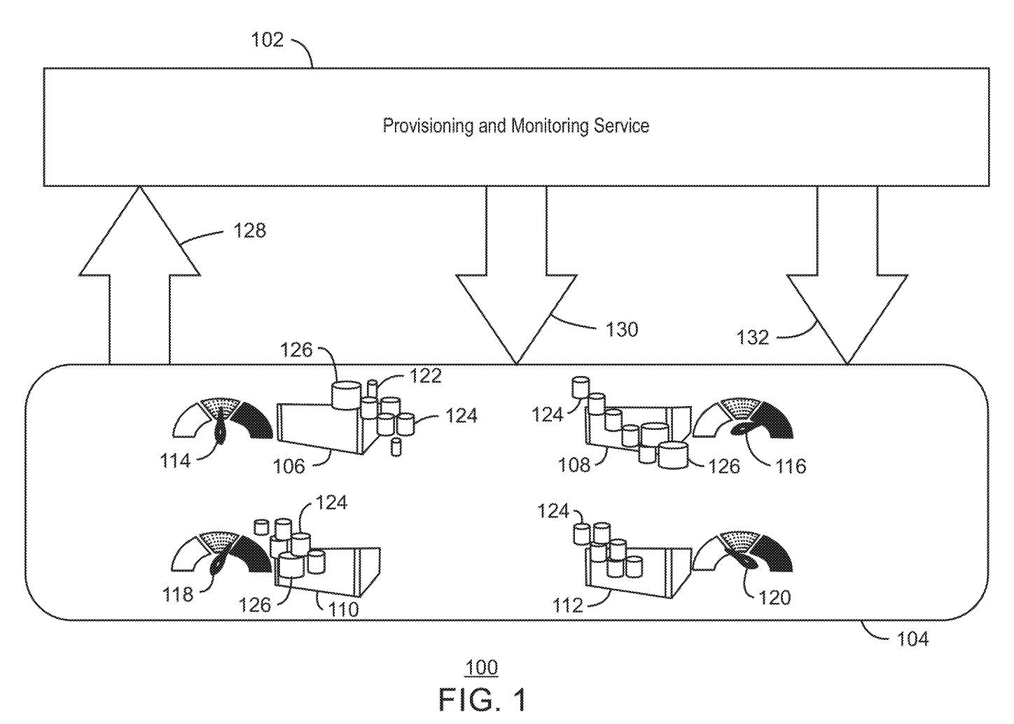

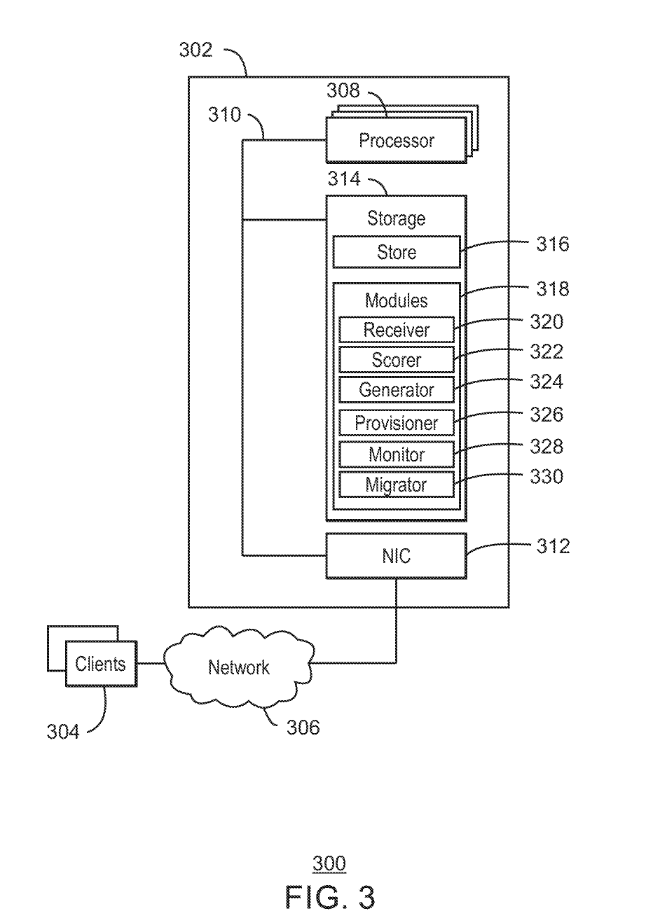

FIG. 1 is a schematic diagram of an example of provisioning volumes based on historical performance data. The example system is generally referred to by the reference number 100 and can be implemented using the example computing device 302 of FIG. 3 below.

The example system 100 includes a provisioning and monitoring service 102 and a federation structure 104 including a number of arrays 106, 108, 110, and 112. The arrays 106, 108, 110, 112 also include current performance ratings 114, 116, 118, and 120, respectively, as indicated by meters. For example, the performance rating for each array can be based on the periodic collection and analysis of historical performance metrics as discussed below. The arrays 106, 108, 110, 112 may also each include any suitable number of drives. The volumes of the drives indicate relative performance consumption of workloads on each array. For example, small volumes 122 indicate relatively small or no performance consumption, medium volumes 124 indicate moderate performance consumption, and large volumes 126 indicate relatively large performance consumption.

As indicated by arrow 128, the provisioning and monitoring service 102 can collect historical performance statistics from each array 106, 108, 110, 112 of the federation structure 104. In some examples, each array may maintain historical data for key performance indicators such as IOPS, bandwidth, and latency. For example, the arrays can each store at least a year's worth of data and possibly more depending on how much storage capacity is set aside for historical performance data.

The provisioning and monitoring service 102 can analyze the overall performance of each array over time based on the historical performance statistics. Analytics are built on top of these metrics to determine volume placement for new provisioning requests. The provisioning and monitoring service 102 can receive a volume provisioning request. The volume provisioning request can include a service level agreement (SLA) for a volume to be provisioned. The SLA can contain a number of performance parameters for the volume that describe the performance to be achieved or maintained for the new volume. The provisioning and monitoring service 102 can then match the SLA performance characteristics for a new volume with two or more arrays that have a suitable overall performance rating. The provisioning and monitoring service 102 can calculate a fitness score for each array based on the performance parameters of the SLA. The provisioning and monitoring service 102 can generate a federation structure 104 including a number of arrays 106, 108, 110, 112 in the storage pool to provision the volume based on the fitness scores of the arrays. For example, the provisioning and monitoring service 102 can use two or more arrays with the highest fitness scores to generate the federation structure 104. As indicated by arrow 130, the provisioning and monitoring service 102 can then provision the volume based, at least in part, on the newly generated federation structure.

As indicated by arrow 132, the provisioning and monitoring service 102 can monitor and migrate volumes based on the SLA. For example, analytics can be built on top of the performance metrics to determine when the federation is to be rebalanced based on the SLA policy to ensure optimal utilization of the storage pool resources. For example, a policy based on the SLA could be defined to maintain an even performance balance across the Federation. For example, the rebalancing of workloads in the federation can be performed using bi-directional peer motion as discussed below with respect to FIG. 2. Using bi-directional peer motion enables the federation of arrays to migrate volumes to other arrays in the federation without impacting the applications that may be using them.

Although the provisioning and monitoring service 102 including the analytics is shown external to the federation structure 104 of FIG. 1, in some examples the provisioning and monitoring service 102 can be implemented inside the federation structure 104. Including the provisioning and monitoring service 102 inside the federation may enable a more optimized solution and reduce the complexity of the clients that manage the federation structure 104.

The diagram of FIG. 1 is not intended to indicate that the example system 100 is to include all of the components shown in FIG. 1. Rather, the example system 100 can include fewer or additional components not illustrated in FIG. 1, e.g., additional arrays, federations, services, etc. Moreover, the diagram of FIG. 1 is not intended to indicate that the components of the example system 100 are to be arranged in any particular order. For example, new volumes can be provisioned after or during the monitoring of previous volumes, etc.

FIG. 2 is a schematic diagram of an example system that can monitor and migrate volumes based on performance data. The example system is generally referred to by the reference number 200 and can be implemented using the example computing device 302 of FIG. 3 below.

The example system 200 includes a provisioning and monitoring service 102 and a federation structure 104 including a number of arrays 106, 108, 110, and 112. The arrays 106, 108, 110, 112 also include updated current performance ratings 202, 204, 206, 208 and previous current performance ratings 114, 116, 118, and 120, respectively, as indicated by meters. For example, the updated performance ratings for each array can be based on the monitoring of performance metrics and migration of the volume between arrays as discussed below. The arrays 106, 108, 110, 112 also each include a number of volumes represented by cylinders 122, 124, 126. The volumes indicate relative performance consumption of workloads on each array. For example, small volumes 122 indicate relatively small or no performance consumption, medium volumes 124 indicate moderate performance consumption, and large volumes 126 indicate relatively large performance consumption.

The examples system 200 illustrates how the analytics of provisioning and monitoring service 102 can be used to periodically monitor the federation structure 104 and automatically trigger a rebalancing of the workloads across the federation as indicated by the arrows. For example, the provisioning and monitoring service 102 can monitor performance of the arrays in the federation for potential SLA conflicts. As indicated by arrow 212, the provisioning and monitoring service 102 can detect a potential SLA conflict. For example, one or more arrays may have workloads that are large than a threshold workload. In some examples, the size of the workload could cause performance metrics to fall below a threshold performance metric based on the SLA.

As indicated by arrow 214, the provisioning and monitoring service 102 can then migrate the one or more volumes to one or more arrays in the pool in response to detecting a potential SLA conflict. In some examples, a form of online migration can be used to migrate volumes. For example, the system can non-disruptively move volumes between arrays while servicing I/O requests from one or more computing devices. In some examples, the migration can be accomplished by invoking a series of bi-directional peer motion requests on specific volumes identified by the monitoring process. For example, a peer motion migration may begin by presenting a new array as a host to a legacy array via any suitable form of storage-area network (SAN) zoning. For example, any available free fibre channel (FC) port can be used for presentation. After a presentation is created, all virtual logical unit numbers (LUNs) on the legacy array can be presented to a newly created host, which can be the destination array in disguise. A logical unit number, as used herein, is a number used to identify a logical unit, which is a device addressed by the SCSI protocol or SAN protocols encapsulating SCSI, such as FC or iSCSI. For example, the newly created host can be the destination array. The host can be zoned to the new array, and the I/O may temporarily flow to the virtual LUNs on both the source and destination arrays. Then the host can be un-zoned from the legacy array. For example, the host can access data on the legacy array through the new array. Copying of data from the legacy array to the new array may then begin. After the data is copied to the destination array, the destination array can be un-zoned from the source array. If all data is migrated, then the peer ports on the destination storage system can be repurposed and the entire source storage system can be disconnected from the hosts. During the migration process, applications on the host device can have uninterrupted access to data. The uninterrupted access is enabled via the use of identical WWNs on the VLUNs on the destination array and source array. Thus, the host device may only detect one VLUN before, during, and after the migration.

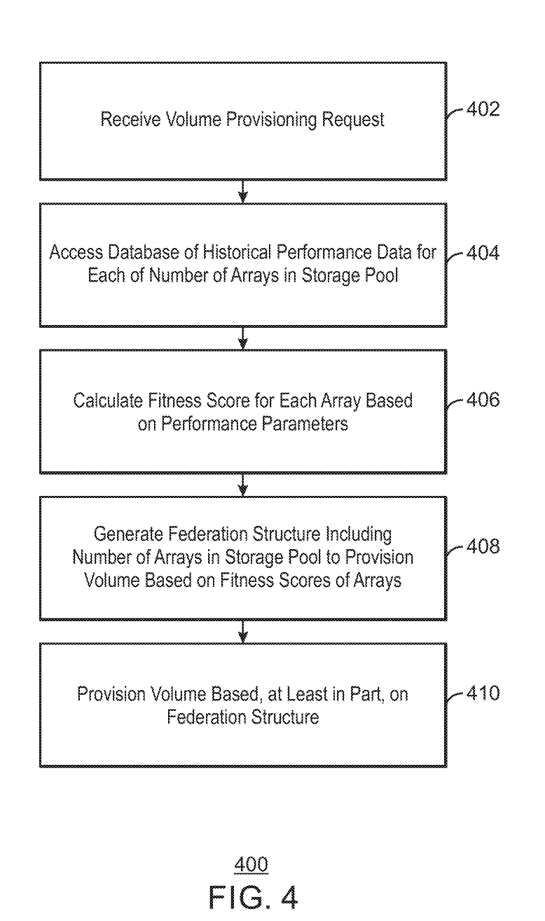

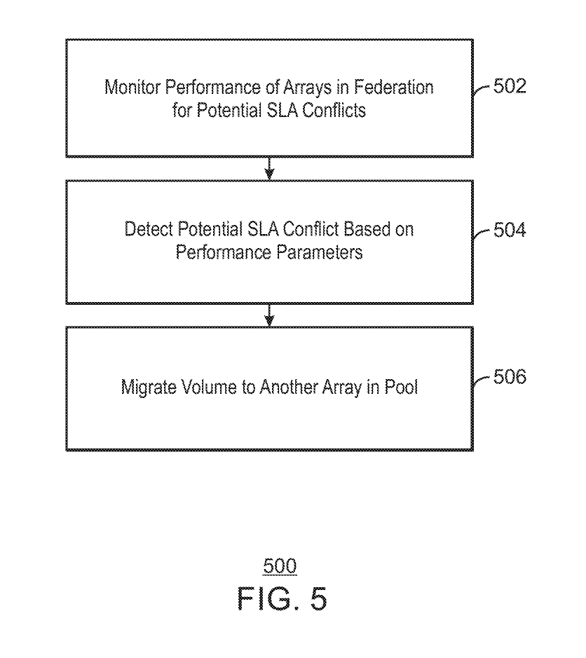

FIG. 3 is a block diagram of a system that can provision and monitor volumes. The system is generally referred to by the reference number 300. In some examples, the system 300 can be used to implement the methods 400 and 500 of FIGS. 4-5 below.

The system 300 may include a computing device 302, and one or more client computers 304, in communication over a network 306. As used herein, a computing device 302 may include a server, a personal computer, a tablet computer, and the like. As illustrated in FIG. 3, the computing device 302 may include one or more processors 308, which may be connected through a bus 310 to a network interface card (NIC) 312. The processors 308 may include a single core, multiples cores, or a cluster of cores in a cloud computing architecture. In some examples, the processors 308 may include a graphics processing unit (GPU). The NIC 312 may connect the computing device 302 to the network 306.

The network 306 may be a local area network (LAN), a wide area network (WAN), or another network configuration. The network 306 may include routers, switches, modems, or any other kind of interface device used for interconnection. The network 306 may connect to several client computers 304. Through the network 306, several client computers 304 may connect to the computing device 302. The client computers 304 may be similarly structured as the computing device 302.

The computing device 302 may have other units operatively coupled to the processor 308 through the bus 310. These units may include non-transitory, tangible, machine-readable storage media, such as storage 314. The storage 314 may include any combinations of hard drives, read-only memory (ROM), random access memory (RAM), RAM drives, flash drives, optical drives, cache memory, and the like. The storage 314 may include a store 316, which can include any performance metrics captured or generated in accordance with the present techniques. Although the store 316 is shown to reside on computing device 302, a person of ordinary skill in the art would appreciate that the store 316 may reside on the computing device 302 or any of the client computers 304.

The storage 314 may include a number of modules 318. For example, the modules 318 may be a set of instructions stored on the storage 314, as shown in FIG. 3. The instructions, when executed by the processor 308, may direct the computing device 302 to perform operations. In some examples, the receiver 320, scorer 322, generator 324, provisioner 326, monitor 328, or migrator 330, may be implemented as logic circuits or computer-readable instructions stored on an integrated circuit such as an Application Specific Integrated Circuit (ASIC), a Field Programmable Gate Array (FPGA), or other type of processor. The receiver 320 can receive a volume provisioning request in a storage management system. For example, the volume provisioning request may correspond to a service level agreement (SLA) for a volume and include a number of performance parameters for the volume.

The scorer 322 can access a database of historical performance data for each of a number of arrays in a storage pool and calculate a fitness score for each array based on the performance parameters. For example, the fitness score can be calculated based on an average IOPS, total bandwidth, latency, or any combination thereof, for each array. For example, the latency can be measure in terms of service time. The generator 324 can generate a federation structure including a number of arrays in the storage pool to provision the volume based on the fitness scores of the arrays. The provisioner 326 can provision the volume based, at least in part, on the federation structure. In some examples, the monitor 328 can monitor performance of the arrays in the federation for potential SLA conflicts. In some examples, the migrator 330 can migrate one or more volumes to other arrays in the pool in response to detecting potential SLA conflicts based on the number of performance parameters. For example, the migrator 330 can invoke a series of bi-directional peer motion requests on specific volumes identified by a monitoring process.

FIG. 4 is a process flow diagram showing a method of provisioning volumes based on historical performance data. The example method is generally referred to by the reference number 400 and can be implemented using the processor 308 of the example system 300 of FIG. 3 above.

At block 402, a storage management system receives a volume provisioning request. For example, the volume provisioning request may correspond to a service level agreement (SLA) for a volume. The volume provisioning request can also include a number of performance parameters for the volume. For example, the number of performance parameters can contain details about the performance level to be achieved or maintained in terms of IOPS.

At block 404, the processor accesses a database of historical performance data for a number of arrays in a storage pool. For example, a global provisioning scheduler can be leveraged and enhanced to initiate periodic collection of historical performance metrics. In some examples, average IOPS can be collected over a minimum of 7 days with samples taken every day. For example, this data can be collected with an updated driver method that collects historical performance metrics.

In some examples, the collected data can be analyzed by the processor. For example, the use of IOPS in a goodness function can be based on the idea that as IOPS increases, the goodness of that array decreases. An example goodness function that produces goodness values that decrease in a polynomial fashion as the current lops on an array increases can be defined by the equation (Eq.1):

$$goodness = - ( \frac{smooth}{max IOPS} ) \times {IOPS}^{2} + 100 \qquad Eq . 1$$

where maxIOPS refers to a maximum IOPS value for the system and the smoothing factor smooth can be a hard-coded value that can be modified to adjust the steepness of polynomial decline. In some examples, the maxIOPS can be a predetermined value based on the specification of a particular array being used. For example, if an array is rated for delivering “over 1 million IOPS” then the maxIOPS can be set at 1,000,000. In some examples, the maxIOPS value can be calculated based on a direct performance test. For example, an array can be tested and a maxIOPS value can be set at the resulting maxIOPS test value.

In another example goodness function, an additional vertical value can be added to the equation resulting in a goodness function that enables control over the inflection point. The resulting goodness function can be calculated using the equation (Eq.2):

$$goodness = - ( \frac{smooth}{max IOPS} ) \times {IOPS}^{2} + 100 + vertical \qquad Eq . 2$$

wherein the new vertical value can be used to change where the goodness value begins to drop off. For example, the vertical value may be preconfigured by an administrator.

In another example, a linear goodness function can be used that produces goodness values that decrease in a linear fashion as the current IOPS on an array increases. A linear goodness function can be calculated using the equation (Eq.3):

$$goodness = 100 \times ( \frac{max IOPS - IOPS}{max IOPS - min IOPS} ) \qquad Eq . 3$$

wherein the minIOPS and maxIOPS values can be configurable or preconfigured and hard-coded.

In another example, an exponential goodness function can be used that produces goodness values for an array that decrease exponentially as the current lops on the array increases. The exponential goodness function can be calculated using the equation (Eq.4):

$$goodness = 100 \times {( 1 + \frac{smooth}{max IOPS} )}^{- IOPS} \qquad Eq . 4$$

wherein the maxIOPS value can be configurable or preconfigured. For example, the maxIOPS can be hard-coded. The smoothing factor smooth can be a hard-coded factor that can be modified to adjust the steepness of the exponential decline.

When an array has a higher IOPS than average, the array can be considered over utilized. The over utilized array can, thus receive a low goodness function so they do not receive any more volumes. When the goodness scores between two storage arrays are very close or the same, the processor can incorporate other performance metrics like service time. For example, when the service time is small, the processor can give a higher goodness score to provision more volumes on that array. Likewise, when the service time is large, the processor may give the array a lower goodness score to prevent provision of further volumes on that array.

At block 406, the processor calculates a fitness score for each array based on the performance parameters. In some examples, the fitness score is to be calculated based on an averaged Input/Output Operations per Second (IOPS), total bandwidth, latency, or any combination thereof, for each array. For example, the processor can analyze the historical performance data and respond with a numerical fitness value that indicates an array's suitability to host the requested volume. In some examples, the processor can analyze the average IOPS previously collected and output a range of fitness values from 0-100, with zero being a worst fit and 100 being a best fit.

At block 408, a processor generates a federation structure including a number of arrays in the storage pool to provision the volume based on the fitness scores of the arrays. For example, the processor can select and provision the volume on one or more arrays with the highest fitness score. The processor can select arrays from the storage pool based on the fitness scores and generate the federation based on the selected arrays.

At block 410, the processor provisions the volume based, at least in part, on the federation structure. For example, the volume can be provisioned on the arrays that make up the federation. In some examples, the processor can also monitor and migrate the volume between arrays as described with regards to FIG. 5 below.

This process flow diagram is not intended to indicate that the blocks of the example method 400 are to be executed in any particular order, or that all of the blocks are to be included in every case. Further, any number of additional blocks not shown may be included within the example method 400, depending on the details of the specific implementation.

FIG. 5 is a process flow diagram showing a method of monitoring and migrating volumes based on performance data. The example method is generally referred to by the reference number 500 and can be implemented using the processor 308 of the example system 300 of FIG. 3 above.

At block 502, the processor monitors performance of the arrays in the federation for potential SLA conflicts. In some examples, the processor can continuously monitor previously requested volume SLA's of method 400 above and the performance of the overall storage pool. The SLA policies can dictate when to automatically and efficiently migrate volumes to other arrays in the federation. In some examples, the processor can continuously analyze average IOPS for each volume and compare the average IOPS against the requested SLA and available storage pools IOPS. For example, if the policy defined on the storage pool is to maintain an even-balanced based on IOPS, then selected volumes can be automatically and efficiently migrated using bi-directional peer motion capability.

At block 504, the processor detects a potential SLA conflict based on the performance-based parameters. In some examples, triggers can be set to indicate the potential SLA violations. When the triggers are flipped, the processor can initiate automated volume migration to the most optimal array in the storage pool. For example, the processor can periodically invoke a process to maintain storage pool balance to determine a list of volumes that can be online migrated to other storage pools in the cluster. In some examples, the migration can be based on previously defined triggers that ensure SLA compliance in the storage pool.

At block 506, the processor migrates one or more volumes to other arrays in the pool. In some examples, the processor can migrate volumes to other arrays by invoking a series of bi-directional peer motion requests on specific volumes identified by the monitoring process.

This process flow diagram is not intended to indicate that the blocks of the example method 500 are to be executed in any particular order, or that all of the blocks are to be included in every case. Further, any number of additional blocks not shown may be included within the example method 500, depending on the details of the specific implementation.

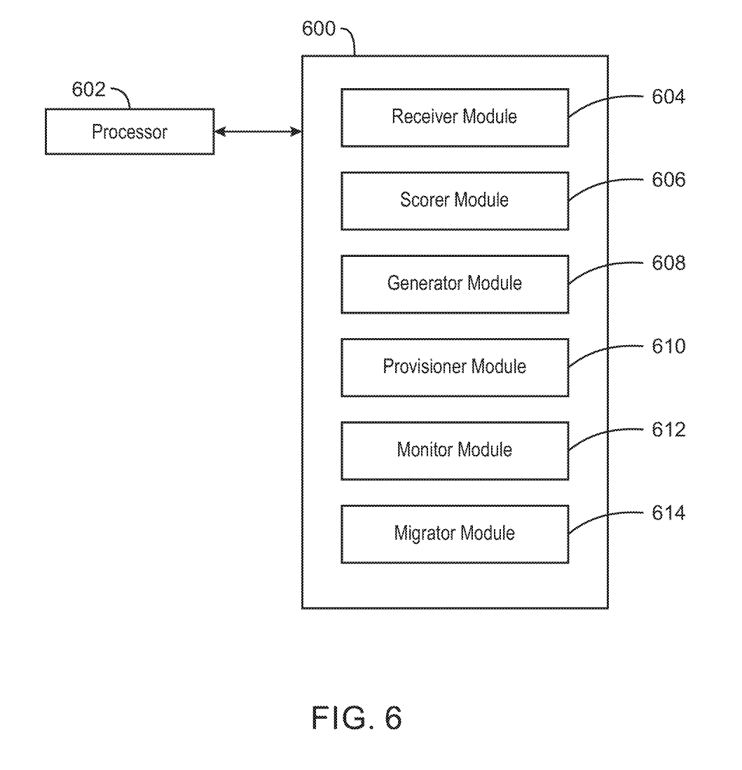

FIG. 6 is a block diagram showing a non-transitory, tangible computer-readable medium that stores code for provision and monitoring of volumes. The non-transitory, tangible computer-readable medium is generally referred to by the reference number 600.

The non-transitory, tangible computer-readable medium 600 may correspond to any storage device that stores computer-implemented instructions, such as programming code or the like. For example, the non-transitory, tangible computer-readable medium 600 may include one or more of a non-volatile memory, a volatile memory, or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 602 generally retrieves and executes the computer-implemented instructions stored in the non-transitory, tangible computer-readable medium 600 for provisioning and monitoring of volumes. A receiver module 604 can receive a volume provisioning request in a storage management system, wherein the volume provisioning request corresponds to a service level agreement (SLA) for a volume and includes a number of performance parameters for the volume.

A scorer module 606 can access a database of historical performance data for each of a number of arrays in a storage pool and calculate a fitness score for each array based on the performance parameters. For example, the scorer module 606 can calculate the fitness score based on an average, total bandwidth, latency, or any combination thereof, for each array.

A generator module 608 can generate a federation structure including a number of arrays in the storage pool to provision the volume based on the fitness scores of the arrays. A provisioner module 610 can provision the volume based, at least in part, on the federation structure. A monitor module 612 can monitor performance of the arrays in the federation for potential SLA conflicts.

A migrator module 614 can migrate one or more volumes to other arrays in the pool in response to detecting a potential SLA conflict based on the number of performance parameters. For example, the migrator module 614 can invoke a bi-directional peer motion request on specific volumes identified by a monitoring process.

Although shown as contiguous blocks, the software components can be stored in any order or configuration. For example, if the computer-readable medium 600 is a hard drive, the software components can be stored in non-contiguous, or even overlapping, sectors.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method for provisioning volumes, comprising:
receiving a volume provisioning request in a storage management system, wherein the volume provisioning request corresponds to a service level agreement (SLA) for a volume and comprises a plurality of performance parameters for the volume;
accessing, via a processor, a database of historical performance data for each of a plurality of arrays in a storage pool;
calculating a fitness score, via the processor, for each array based on the performance parameters;
generating, via the processor, a federation structure comprising a plurality of arrays in the storage pool to provision the volume based on the fitness scores of the arrays; and
provisioning the volume based, at least in part, on the federation structure.

2. The method of claim 1, further comprising:
monitoring, via the processor, performance of the arrays in the federation for potential SLA conflicts; and
migrating, via the processor, one or more volumes to other arrays in the pool in response to detecting potential SLA conflicts based on the plurality of performance parameters.

3. The method of claim 1, wherein the fitness score is to be calculated based on an averaged Input/Output Operations per Second (IOPS), total bandwidth, latency, or any combination thereof, for each array.

4. The method of claim 1, wherein generating the federation structure further comprises selecting arrays from the storage pool based on the fitness scores and generating the federation based on the selected arrays.

5. The method of claim 1, further comprising migrating, via the processor, one or more volumes by invoking a series of bi-directional peer motion requests on specific volumes identified by a monitoring process.

6. A system for provisioning volumes, comprising:
a receiver to receive a volume provisioning request in a storage management system, wherein the volume provisioning request corresponds to a service level agreement (SLA) for a volume and comprises a plurality of performance parameters for the volume;
a scorer to access a database of historical performance data for each of a plurality of arrays in a storage pool and calculate a fitness score for each array based on the performance parameters;
a generator to generate a federation structure comprising a plurality of arrays in the storage pool to provision the volume based on the fitness scores of the arrays; and
a provisioner to provision the volume based, at least in part, on the federation structure.

7. The system of claim 6, further comprising a monitor to monitor performance of the arrays in the federation structure for potential SLA conflicts.

8. The system of claim 6, further comprising a migrator to migrate one or more volumes to other arrays in the storage pool in response to detecting a potential SLA conflict based on the plurality of performance parameters.

9. The system of claim 6, further comprising a migrator to invoke a series of bi-directional peer motion requests on specific volumes identified by a monitoring process.

10. The system of claim 6, wherein the fitness score is to be calculated based on an average Input/Output Operations per Second (IOPS), total bandwidth, latency, or any combination thereof, for each array.

11. A non-transitory, tangible computer-readable medium, comprising instructions to, when executed by a processor, direct the processor to:
receive a volume provisioning request in a storage management system, wherein the volume provisioning request corresponds to a service level agreement (SLA) for a volume and comprises a plurality of performance parameters for the volume;
access a database of historical performance data for each of a plurality of arrays in a storage pool and calculate a fitness score for each array based on the performance parameters;
generate a federation structure comprising a plurality of arrays in the storage pool to provision the volume based on the fitness scores of the arrays; and
provision the volume based, at least in part, on the federation structure.

12. The non-transitory, tangible computer-readable medium of claim 11, further comprising instructions to monitor performance of the arrays in the federation for potential SLA conflicts.

13. The non-transitory, tangible computer-readable medium of claim 11, further comprising instructions to migrate one or more volumes to other arrays in the storage pool in response to detecting a potential SLA conflict based on the plurality of performance parameters.

14. The non-transitory, tangible computer-readable medium of claim 11, further comprising instructions to calculate the fitness score based on an average Input/Output Operations per Second (IOPS), total bandwidth, latency, or any combination thereof, for each array.

15. The non-transitory, tangible computer-readable medium of claim 11, further comprising instructions to invoke a bi-directional peer motion request on specific volumes identified by a monitoring process.
